(19) United States
(12) Patent Application Publication
(10) Pub. No.: US 2022/0185724 A1
(43) Pub. Date: Jun. 16, 2022

(54) GLASS FRIT, COATED ARTICLE INCLUDING A BLACK ENAMEL COATING FORMED FROM THE SAME, AND METHOD FOR MANUFACTURING THE COATED ARTICLE

(71) Applicant: SAINT-GOBAIN GLASS FRANCE, COURBEVOIE (FR)

(72) Inventors: Jin Woo HAN, Seoul (KR); Eun Hack JANG, Gunsan-si (KR)

(21) Appl. No.: 17/441,949

(22) PCT Filed: Apr. 23, 2020
(86) PCT No.: PCT/KR2020/005357

§ 371 Date: Sep. 22, 2021

(30) Foreign Application Priority Data
Apr. 24, 2019 (KR) 10-2019-0047912

(51) Int. Cl. C03C 8/04; C03C 8/16; C03C 4/02; C03C 3/066; C03C 17/04; C03C 17/36; C03B 27/012

(52) U.S. Cl. CPC C03C 8/04; C03C 8/16; C03C 4/02; C03C 3/066; C03C 17/04; C03C 17/3618; C03C 2218/32; C03C 2204/00; C03C 2207/00; C03C 17/3686; C03C 17/3681; C03C 2217/732; C03C 2218/119; C03B 27/012

(57) ABSTRACT

A glass frit for forming a black enamel coating includes Si at 6.5 mol % to 6.9 mol %, B at 9.0 mol % to 9.3 mol %, Bi at 13.0 mol % to 13.4 mol %, Zn at 6.0 mol % to 6.3 mol %, and Al at 1.5 mol % to 2.0 mol %, and Co, Ni, and Fe, wherein a total amount of Co, Ni, and Fe is 2.9 mol % to 3.5 mol % of the glass frit in a molar ratio.

### TECHNICAL FIELD

The present disclosure relates to a glass frit, a coated article including a black enamel coating formed therefrom, and a method for manufacturing a coated article. In detail, it is a glass frit for forming a black enamel coating, and it relates to a glass frit including no pigment and but being able to form a black enamel coating, a coated article including a black enamel coating formed therefrom, and a method for manufacturing a coated article.

### BACKGROUND ART

Printed glass substrates are used for multiple purposes, such as, ornamental and/or functional aims in the fields of industrial, office, or residential buildings, glazing for vehicles, or oven doors and refrigerator doors. To control heat, low-emissivity glass is applied to glass substrates. For example, in the case of applying it to an oven door, a low-emissivity coating is applied to at least one side of a glass substrate so as to improve insulation of the oven and prevent burns when a user contacts the oven door.

A low-emissivity glass is a glass on which a low-emissivity layer including a metal having high reflectance in an infrared region such as silver (Ag) is deposited as a thin film. The printed glass substrate may be obtained by applying a dark-colored enamel coating to the glass on which a low-emissivity layer is deposited.

Particularly, to obtain a black enamel coating, an additional pigment made of a ceramic powder is included in a composition including a glass frit forming an enamel coating. In this case, the black enamel coating is obtained through a heat treatment, and the pigment is not completely melted in the glass frit but exists as a phase that is separated from the glass frit, so durability is bad. Particularly, when exposed to an acidic environment, it is easily corroded and has poor acid resistance.

The above information disclosed in this Background section is only for enhancement of understanding of the background of the invention and therefore it may contain information that does not form the prior art that is already known in this country to a person of ordinary skill in the art.

### DISCLOSURE OF INVENTION

The present invention has been made in an effort to provide a glass frit for acquiring a black enamel coating for realizing an excellent black color including no additional pigment, having excellent acid resistance, and having excellent surface roughness when applied to a low-emissivity coated glass, a coated article including a black enamel coating formed therefrom, and a manufacturing method thereof.

However, tasks to be solved by exemplary embodiments of the present invention may not be limited to the above-described task, and may be extended in various ways within a range of technical scopes included in the present invention

An exemplary embodiment of the present invention provides a glass frit for forming a black enamel coating includes: Si at 6.5 mol % to 6.9 mol %, B at 9.0 mol % to 9.3 mol %, Bi at 13.0 mol % to 13.4 mol %, Zn at 6.0 mol % to 6.3 mol %, and Al at 1.5 mol % to 2.0 mol %, and Co, Ni, and Fe, wherein a total amount of Co, Ni, and Fe is 2.9 mol % to 3.5 mol % of the glass frit in a molar ratio.

A content of Co may be 1 to 2 mol %, a content of Ni may be 0.5 to 1.1 mol %, and a content of Fe may be 0.5 to 1.5 mol % of the glass frit in a molar ratio.

The glass frit may include Si at 6.6 mol % to 6.8 mol %, B at 9.0 mol % to 9.2 mol %, Bi at 13.1 mol % to 13.3 mol %, Zn at 6.1 mol % to 6.3 mol %, Al at 1.7 mol % to 1.8 mol %, Co at 1.0 mol % to 2.0 mol %, Ni at 0.5 mol % to 1.1 mol %, and Fe at 0.5 mol % to 1.5 mol % in a molar ratio.

The glass frit may further include at least one selected from Na and Li at more than 0 and less than 1 mol %.

A composition for forming a black enamel coating according to the embodiment of the present invention includes: a glass frit as described above; and an organic vehicle.

The composition may not include a pigment for developing a black color.

Yet according to the embodiment of the present invention, a coated article includes a transparent substrate, a multilayer thin film coating disposed on the transparent substrate, and a patterned portion in which a black enamel coating formed on at least part of the transparent substrate as a predetermined pattern, wherein the multilayer thin film coating includes a first dielectric layer, a metallic functional layer having an infrared reflection function, and a second dielectric layer, which are sequentially disposed in a direction away from the transparent substrate, and the black enamel coating is formed from a glass frit including Si at 6.5 mol % to 6.9 mol %, B at 9.0 mol % to 9.3 mol %, Bi at 13.0 mol % to 13.4 mol %, Zn at 6.0 mol % to 6.3 mol %, Al at 1.5 mol % to 2.0 mol %, and Co, Ni, and Fe, wherein a total amount of Co, Ni, and Fe is 2.9 mol % to 3.5 mol % of the glass frit in a molar ratio.

Surface roughness (Ra) of the black enamel coating may be less than 1 μm.

CIELAB color coordinates (a* and b*) of a reflection color of the surface, on which side the black enamel coating is not formed in a patterned portion, may be −1.0 to 1.0.

A thickness of the black enamel coating may be 5 μm to 30 μm.

Yet according to the embodiment of the present invention provides a method for manufacturing a coated article comprising: printing a composition for forming a black enamel coating so as to have a predetermined pattern on at least part of a transparent substrate having a multilayer thin film thereon; and forming a patterned portion including the black enamel coating by carrying out a heat treatment of the transparent substrate on which the multilayer thin film coating and the composition for forming the black enamel coating are formed, wherein the composition for forming the black enamel coating includes a glass frit including Si at 6.5 mol % to 6.9 mol %, B at 9.0 mol % to 9.3 mol %, Bi at 13.0 mol % to 13.4 mol %, Zn at 6.0 mol % to 6.3 mol %, Al at 1.5 mol % to 2.0 mol %, and Co, Ni, and Fe, wherein a total amount of Co, Ni, and Fe is 2.9 mol % to 3.5 mol % of the glass frit in a molar ratio, and an organic vehicle.

The multilayer thin film coating may include a first dielectric layer, a metallic functional layer having an infrared reflection function, and a second dielectric layer, which are sequentially disposed in a direction away from the transparent substrate.

The heat treatment may be carried out at a temperature of 630° C. to 730° C. for 150 seconds to 300 seconds.

Components in the glass frit are entirely melted by the heat treatment so as to exist as one phase.

The manufacturing method may further include drying and preheating the composition for forming the black enamel coating before the heat treatment.

The heat treatment may be a tempering process of the transparent substrate.

According to the exemplary embodiment of the present invention, the glass frit for acquiring a black enamel coating for realizing an excellent black color including no additional pigment, having excellent acid resistance, and having excellent surface roughness when applied to a low-emissivity coated glass, the coated article including a black enamel coating formed therefrom, and the manufacturing method thereof are provided.

[Mode for Invention]

It will be understood that, although the terms first, second, third, etc. may be used herein to describe various elements, components, regions, layers, and/or sections, they are not limited thereto. These terms are only used to distinguish one element, component, region, layer, or section from another element, component, region, layer, or section. Thus, a first element, component, region, layer, or section discussed below could be termed a second element, component, region, layer, or section without departing from the teachings of the present invention.

The technical terms used herein are to simply mention a particular exemplary embodiment and are not meant to limit the present invention. An expression used in the singular encompasses an expression of the plural, unless it has a clearly different meaning in the context. In the specification, it is to be understood that terms such as “including”, “having”, etc., are intended to indicate the existence of specific features, regions, numbers, stages, operations, elements, components, or combinations thereof disclosed in the specification, and are not intended to preclude the possibility that one or more other specific features, regions, numbers, operations, elements, components, or combinations thereof may exist or may be added.

When a part is referred to as being “on” another part, it can be directly on the other part or intervening parts may also be present. In contrast, when an element is referred to as being “directly on” another element, there are no intervening elements therebetween.

Unless otherwise defined, all terms used herein, including technical or scientific terms, have the same meanings as those generally understood by those with ordinary knowledge in the field of art to which the present invention belongs. Such terms as those defined in a generally used dictionary are to be interpreted to have the same meanings as contextual meanings in the relevant field of art, and are not to be interpreted to have idealized or excessively formal meanings unless clearly defined in the present application.

Hereinafter, exemplary embodiments of the present invention will be described in detail so that those skilled in the art to which the present invention pertains may easily implement the exemplary embodiments.

As those skilled in the art would realize, the described embodiments may be modified in various different ways, all without departing from the spirit or scope of the present invention.

The glass frit according to an exemplary embodiment of the present invention represents a frit for forming a black enamel coating, and it includes Si (6.5 to 6.9 mol %), B (9.0 to 9.3 mol %), Bi (13.0 to 13.4 mol %), Zn (6.0 to 6.3 mol %), and Al (1.5 to 2.0 mol %), and further includes Co, Ni, and Fe (a total of 2.9 to 3.5 mol %) in a molar ratio.

The content represents molar ratios of respective elements in the glass frit, and they may exist in a metal oxides form in a raw material stage for manufacturing a glass frit. Namely, the raw materials in an oxides form, such as SiO₂, B₂O₃, Bi₂O₃, ZnO, Al₂O₃, CO₃O₄, NiO, Fe₂O₃, Li₂O, Na₂O, MgO, or CaO, are melted, cured, and crushed to generate a glass frit in a powder form. Therefore, the glass frit may further include oxygen atoms and a small amount of impurities (that may be input from a furnace in the melting progress) input from the outside during the melting process in addition to the above-described elements.

Among the elements, which must be included, are Si, B, Bi, Zn, Al, Co, Ni, and Fe, and the content thereof may further preferably be Si at 6.6 to 6.8 mol %, B at 9.0 to 9.2 mol %, Bi at 13.1 to 13.3 mol %, Zn at 6.1 to 6.3 mol %, Al at 1.7 to 1.8 mol %, Co at 1.0 to 2.0 mol %, Ni at 0.5 to 1.1 mol %, and Fe at 0.5 to 1.5 mol % in the molar ratio. In addition to the above-noted elements, they may further include at least one element (0 to 1 mol %) selected from among Li, Na, Mg, Ca, Sr, and Ba depending on the characteristic or use of the glass frit to be obtained.

Here, Si and B are basic raw materials functioning as a glass forming agent, and it may be ideal when the content of the glass forming agent (Si+B) is greater in the viewpoint of chemical durability, but when the content is very high, a melting point and a glass transition temperature (Tg) increase to worsen productivity, and fast plastic forming at the desired temperature is impossible, so it is necessary to appropriately control the content.

The Bi exists in a Bi₂O₃ form in the raw material stage, it represents a component having a low melting point, it may react with a dielectric material (e.g., Si₃N₄) included in a multilayer thin film coating to form a Bi—Si—O—N glass, and generates bubbles of O₂ and N₂ in the above-noted process. Because of this, the greater the content, the weaker the chemical durability, so the content has to be controlled to be equal to or less than the upper limit value.

The Zn is an ionic material, it makes a flexible network structure of the glass, it steeply reduces viscosity, and it accelerates removal of the bubbles in a process of forming a black enamel coating layer. Therefore, in order to form a stable surface of the black enamel coating which obtained by printing a composition for forming a black enamel coating on a transparent substrate to which a multilayer thin film coating formed and heat-treating the same, its content has to be controlled to be equal to or greater than the lower limit value. Thus, when Zn is included at less than the lower limit value, the bubbles are not fluently removed, so the surface roughness of the black enamel coating increases, and the plastic forming temperature increases, which is inap-propriate. On the contrary, when the content of Zn become very high because of the above-noted characteristic, the chemical durability may be deteriorated, so the content must be controlled to be equal to or less than the upper limit value. The Al functions as a controlling agent of the thermal expansion coefficient, so the content need be controlled within the range so as to properly control the thermal expansion coefficient.

Further, a task of the present invention is to acquire an enamel coating displaying excellent black with the components included in the glass frit without adding a black pigment in addition to the glass frit, and to achieve this, the content of Co, Ni, and Fe need to be appropriately controlled. Namely, the excellent black color may be obtained by controlling their total amount to be 2.9 to 3.5 mol %, and in detail, controlling Co at 1.0 to 2.0 mol %, Ni at 0.5 to 1.1 mol %, and Fe at 0.5 to 1.5 mol %.

Here, the excellent black color can be defined by measuring a reflected color from a side on which no coating is formed after forming a black enamel coating on a transparent glass substrate, and in general, when absolute values of the CIELAB color coordinates (a* and b*) are less than 1, it may be seen to be black, so it may be considered to be an excellent black color. When one of the absolute values of a* and b* becomes equal to or greater than 1, it may be recognized to be slightly reddish black or slightly bluish black, which is undesirable.

When the content of Co, Ni, and Fe is out of the range of 2.9 to 3.5 mol %, or out of the range of Co from 1.0 to 2.0 mol %, Ni from 0.5 to 1.1 mol %, and Fe from 0.5 to 1.5 mol %, the absolute values of the CIELAB color coordinates (a* and b*) become equal to or greater than 1, so it may be recognized to be red, blue, or black.

Further, according to the glass frit according to the present invention, excellent durability and acid resistance may be achieved. Namely, in the prior art, to obtain a black enamel coating, a composition (or a paste) for a black enamel coating including the glass frit made of a metal oxide and a black pigment is formed, such as, a pigment formed by ceramic powder. In this case, when a heat treatment is performed to form a black enamel coating, the pigment is not completely melted but it exists as another phase in the melted glass frit. Namely, as the pigment does not participate in a network of the glass frit but exists as a lump in a matrix of the glass frit, a structure that may be easily broken on a border of the pigment and the frit matrix is generated, and the durability, such as acid resistance, is deteriorated.

However, according to the glass frit according to the present invention, it is possible to realize the black color with the components for forming the glass frit without additional pigments, thereby solving the drawback of deteriorating durability. Particularly, components of Co, Ni, and Fe which are added to realize the black color are transition metals, they may freely participate in the network formation in the network of the glass frit, and by this, the network of the glass frit is made firm and durability is increased.

On the other hand, according to an exemplary embodiment of the present invention, the glass frit may form the enamel coating with an excellent surface quality even when the glass frit is applied to a coated article (low-emissivity glass, etc.,) including a multilayer thin film coating with a metallic functional layer. This will be described together with a coated article to be described and a manufacturing method thereof.

The coated article according to an exemplary embodiment of the present invention includes a transparent substrate, and a multilayer thin film coating formed on the transparent substrate, and also includes a patterned portion formed with a predetermined pattern on at least part of the transparent substrate.

The transparent substrate is not specifically limited, but it is preferably manufactured of an inorganic material such as glass or an organic material of a polymer matrix.

The multilayer thin film coating includes a first dielectric layer, a metallic functional layer having an infrared ray reflecting function, and a second dielectric layer, which are disposed in a direction away from the transparent substrate, and it may further include a blocking layer stacked on at least one of a top side and a bottom side of the metallic functional layer.

The first dielectric layer and the second dielectric layer may include a metal oxide, a metal nitride, or a metal oxynitride. The metal may include at least one of titanium (Ti), hafnium (Hf), zirconium (Zr), niobium (Nb), zinc (Zn), bismuth (Bi), lead (Pb), indium (In), tin (Sn), and silicon (Si). Preferably, it may include a silicon nitride (Si₃N₄). Further, the first dielectric layer and the second dielectric layer may be respectively formed to be a single layer, or they may include more than two dielectric layers. In this instance, a zinc oxide may be included in the dielectric layer provided near the metallic functional layer, and the silicon nitride may be included in the dielectric layer provided far from the metallic functional layer, but they are not specially limited. Further, Al, etc. may be additionally doped to the dielectric layer. By doping Al, the dielectric layer may be smoothly formed in the manufacturing process. The dielectric layer may include a doping agent, for example, fluorine, carbon, nitrogen, boron, phosphorus, and/or aluminum. Namely, a target used in a sputtering process is doped with aluminum, boron, or zirconium, thereby improving the optical property of the coating and increasing the formation speed of the dielectric layer formed by sputtering.

When the dielectric layer includes a silicon nitride, zirconium may be doped, and Zr(Si+Zr) may be 10 to 50% in a molar ratio. When the zirconium is doped, a re-fractive index of the dielectric layer may be increased and transmittance may be increased. In detail, the dielectric layer may be a zirconium-doped silicon nitride, but is not limited thereto.

The metallic functional layer has an infrared ray (IR) reflection characteristic. The metallic functional layer may include at least one of gold (Au), copper (Cu), palladium (Pd), aluminum (Al), and silver (Ag). In detail, it may include silver or a silver alloy. The silver alloy may include a silver-gold alloy and a silver-palladium alloy.

Here, the metallic functional layer may include a single layer (a single Low-E coating), or may include at least two metallic functional layers. For example, when including two metallic functional layers (a double Low-E coating), the multilayer thin film coating includes a first dielectric layer, a first metallic functional layer, a second dielectric layer, a second metallic functional layer, and a third dielectric layer, which are disposed in this order in a direction away from the transparent substrate. The configuration of the third dielectric layer may be equivalent to or different from the above-described first and second dielectric layers. In this case, a sum of thicknesses of the first and second metallic functional layers may be 27 to 33 nm. When they are very thin, a solar heat gain coefficient (SHGC) may increase. When they are very thick, the color coordinates of a transmission color may be distant from the blue color.

In an exemplary embodiment of the present invention, a blocking layer stacked on at least one of a top side and a bottom side of the metallic functional layers (a first metallic functional layer and a second metallic functional layer) and preventing the metallic functional layer from being oxidized may be further included. The blocking layer may include at least one of titanium, nickel, chromium, and niobium. In further detail, it may include a nickel-chromium alloy. In this case, part of chromium may be changed to a nitride during a sputtering process. In addition, the thickness of the blocking layer may be 0.5 to 2 nm.

An over-coating layer may further be included on the outermost portion of the multilayer thin film coating. Namely, the over-coating layer may be formed on the second dielectric layer in the case of the single Low-E coating, or it may be formed on the third dielectric layer in the case of a double Low-E coating, and when an additional layer is included, it may be formed on the farthest layer from the transparent substrate on the multilayer thin film coating. The over-coating layer may be at least one of TiOₓ, TiOₓN_{y}, TiNₓ, and Zr dopants. In further detail, the over-coating layer may include TiZrₓO_{y}N_{z} (here, x is 0.5 to 0.7, y is 2.0 to 2.5, and z is 0.2 to 0.6). By including the over-coating layer, the layers included in the multilayer thin film coating may be prevented from being damaged.

In an exemplary embodiment of the present invention, the patterned portion formed with a predetermined pattern on at least part of the transparent substrate includes a black enamel coating formed with the predetermined pattern, the black enamel coating includes Si at 6.5 to 6.9 mol %, B at 9.0 to 9.3 mol %, Bi at 13.0 to 13.4 mol %, Zn at 6.0 to 6.3 mol %, and Al at 1.5 to 2.0 mol % in the molar ratio, and is formed of the glass frit including Co, Ni, and Fe at the total of 2.9 to 3.5 mol %. Further, the thickness of the enamel coating may be 5 μm to 15 μm, but is not limited thereto.

In an exemplary embodiment of the present invention, the black enamel coating may be obtained by printing the composition including a glass frit forblack enamel coating on the transparent substrate on which a multilayer thin film coating including a metallic functional layer with infrared ray reflecting function and performing a direct heat treatment. Particularly, it includes Si at 6.5 to 6.9 mol %, B at 9.0 to 9.3 mol %, Bi at 13.0 to 13.4 mol %, Zn at 6.0 to 6.3 mol %, and Al at 1.5 to 2.0 mol % in the molar ratio, and the surface roughness of the black enamel coating becomes less than 1 μm by forming a black enamel coating from the glass frit including Co, Ni, and Fe at the total of 2.9 to 3.5 mol %, thereby acquiring excellent surface quality.

When forming an enamel coating on the transparent substrate on which a multilayer thin film coating having a metallic functional layer with infrared ray reflecting function, gas bubbles are generated by a reaction between the multilayer thin film coating and the glass frit in the process of applying a glass frit on the multilayer thin film coating and performing a heat treatment, and the surface roughness of the formed enamel coating becomes very high therefore. However, when applying the glass frit according to the present invention, generation of the bubbles may be suppressed to the maximum, and the generated bubbles may be quickly discharged to the outside, thereby acquiring the enamel coating with an excellent surface characteristic.

A method for manufacturing a coated article according to an exemplary embodiment of the present invention will now be described.

First, a multilayer thin film coating comprising a first dielectric layer, a metallic functional layer, and a second dielectric layer which are stacked in order is formed on the transparent substrate. In this instance, a blocking layer for preventing oxidization of the metallic functional layer may further be formed between the dielectric layer and the metallic functional layer selectively.

Respective layers of the multilayer thin film coating may be formed by a method of physical vapor deposition (PVD) such as a sputtering.

A composition for forming a black enamel coating is printed on at least part of the multilayer thin film coating so as to have a predetermined pattern.

The composition of black enamel coating includes Si at 6.5 to 6.9 mol %, B at 9.0 to 9.3 mol %, Bi at 13.0 to 13.4 mol %, Zn at 6.0 to 6.3 mol %, and Al at 1.5 to 2.0 mol % in the molar ratio, and it may include Co, Ni, and Fe at the total of 2.9 to 3.5 mol % to form a glass frit and include an organic vehicle to form a paste. It may further include a liquid supplemental agent for controlling viscosity of the paste (e.g., a solvent). The composition for forming the paste-type black enamel coating is printed on the mul-tilayered thin film coating in a preferable pattern by a method such as screen printing.

Here, the composition for forming a black enamel coating comprises a glass frit, an organic vehicle, and a liquid supplemental agent, and no additional black pigment is added therein. Namely, as described above, durability of the black enamel coating obtained by the heat treatment to be described may be improved.

The glass frit is uniformly dispersed in an organic vehicle. Here, the organic vehicle may be formed of a volatile material, so it may be removed by a preheating or drying process after the composition for forming an enamel coating is printed. The process temperature in this instance is equal to or less than the softening point of the glass frit, the temperature is at which only the organic vehicle can be vaporized, it is selectable depending on the type of the organic vehicle, and for example, the process may be performed at a temperature of 70° C. to 170° C.

A patterned portion including a black enamel coating is formed by performing a heat treatment on a laminated body which formed after the organic vehicle removed from the pattern formed by the composition for forming a black enamel coating.

The heat treatment may be performed at a temperature of 630° C. to 730° C. for 150 seconds to 300 seconds. When the heat treatment is performed at the corresponding temperature, the glass frit included in the composition for forming a black enamel coating is melted to form one single phase. Namely, no additional pigment for realizing the black color is included, so all the components included in the glass frit are melted by the heat treatment to form a state such that they may not be separated from each other. Namely, a weak configuration on the interface between the phases that may be generated when there are individual phases are provided is not included, so the black enamel coating acquired therefrom has excellent durability.

In addition, in the corresponding heat treatment process, in the case of the glass frit having the composition of the present invention, generation of bubbles by the reaction with the multilayer thin film coating is maximally suppressed, and even when the bubbles are generated, they may quickly come out from the black enamel coating by the high-temperature heat treatment, thereby preventing the increase of surface roughness when the bubbles remain in the black enamel coating.

Further, by the heat treatment, a process for reinforcing the transparent substrate, namely, the tempering process, may also be performed. That is, the heat treatment process for forming a black enamel coating is performed at the sufficiently high temperature, so the sufficiently reinforced transparent substrate may be obtained without an additional tempering process.

According to the manufacturing method according to an exemplary embodiment of the present invention, the black enamel coating is formed by using the glass frit not including an additional black pigment but including essential elements with a specific content, particularly the glass frit including Co, Ni, and Fe at the total amount of 2.9 to 3.5 mol %, wherein the content of Co is 1 to 2 mol %, the content of Ni is 0.5 to 1.1 mol %, and the content of Fe is 0.5 to 1.5 mol %, so the glass frit is melted in the heat treatment process and it exists as one single phase thereafter, thereby acquiring a black enamel coating with improved durability (or acid resistance). Further, when the black enamel coating is formed on the glass substrate on which the multilayer thin film coating having an infrared ray reflection function is formed, the generation of bubbles may be suppressed and the black enamel coating with the surface roughness that is less than 1 μm may be obtained.

The present invention will now be described in further detail with reference to an experimental example. However, the experimental example exemplifies the present invention, and the present invention is not limited thereto.

### EXPERIMENTAL EXAMPLE

A glass frit including metal oxides with mole ratios (mol %) as expressed in Table 1 is prepared.

TABLE 1

| | SiO₂ | B₂O₃ | Bi₂O₃ | ZnO | Al₂O₃ | Co₃O₄ | NiO | Fe₂O₃ |
|---|---|---|---|---|---|---|---|---|
| Exemplary | 25.3 | 17.0 | 24.8 | 23.1 | 3.3 | 2.4 | 3.0 | 1.2 |
| Embodiment 1 | | | | | | | | |
| Exemplary | 25.3 | 17.0 | 24.8 | 23.1 | 3.3 | 1.2 | 3.0 | 2.4 |
| Embodiment 2 | | | | | | | | |
| Exemplary | 25.3 | 17.0 | 24.8 | 23.0 | 3.3 | 1.5 | 3.7 | 1.5 |
| Embodiment 3 | | | | | | | | |
| Exemplary | 25.3 | 1.72 | 24.8 | 23.2 | 3.3 | 2.2 | 2.0 | 2.0 |
| embodiment 4 | | | | | | | | |
| Comparative | 25.2 | 16.9 | 24.7 | 23.7 | 3.3 | 6.2 | 0 | 0 |
| Example 1 | | | | | | | | |
| Comparative | 25.2 | 16.9 | 24.7 | 23.8 | 3.3 | 0 | 0 | 6.0 |
| Example 2 | | | | | | | | |
| Comparative | 25.4 | 17.0 | 24.8 | 22.2 | 3.3 | 0 | 7.3 | 0 |
| Example 3 | | | | | | | | |
| Comparative | 25.4 | 17.2 | 24.9 | 20.1 | 3.3 | 2.2 | 3.4 | 3.4 |
| Example 4 | | | | | | | | |
| Comparative | 25.4 | 17.2 | 24.8 | 21.7 | 3.3 | 2.2 | 2.7 | 2.7 |
| Example 5 | | | | | | | | |
| Comparative | 30.4 | 20.4 | 24.8 | 11.6 | 3.5 | 1.2 | 4.0 | 4.0 |
| Example 6 | | | | | | | | |
| Comparative | 24.7 | 16.5 | 24.2 | 3.2 | 6.7 | 11.3 | 6.7 | 6.7 |
| Example 7 | | | | | | | | |

In the exemplary embodiments and comparative examples, values that are changed by the mole ratios (mol %) of atoms of the respective glass frits are expressed in Table 2.

TABLE 2

| | | | | | | | | | Co + | |
|---|---|---|---|---|---|---|---|---|---|---|
| | | | | | | | | | Ni + | |
| | Si | B | Bi | Zn | Al | Co | Ni | Fe | Fe | O |
| Exemplary | 6.7 | 9.0 | 13.2 | 6.1 | 1.8 | 1.9 | 0.8 | 0.6 | 3.3 | 59.8 |
| Embodiment 1 | | | | | | | | | | |
| Exemplary | 6.8 | 9.1 | 13.3 | 6.2 | 1.8 | 1.0 | 0.8 | 1.3 | 3.1 | 59.9 |
| Embodiment 2 | | | | | | | | | | |
| Exemplary | 6.8 | 9.1 | 13.3 | 6.2 | 1.8 | 1.2 | 1.0 | 0.8 | 3.0 | 59.8 |
| Embodiment 3 | | | | | | | | | | |
| Exemplary | 6.7 | 9.1 | 13.1 | 6.1 | 1.7 | 1.7 | 0.5 | 1.1 | 3.3 | 59.9 |
| Embodiment 4 | | | | | | | | | | |
| Comparative | 6.4 | 8.6 | 12.6 | 6.1 | 1.7 | 4.8 | 0 | 0 | 4.8 | 59.8 |
| Example 1 | | | | | | | | | | |
| Comparative | 6.7 | 8.9 | 13.1 | 6.3 | 1.7 | 0 | 0 | 3.2 | 3.2 | 60.1 |
| Example 2 | | | | | | | | | | |
| Comparative | 7 | 9.4 | 13.8 | 6.2 | 1.8 | 0 | 2 | 0 | 2 | 59.8 |
| Example 3 | | | | | | | | | | |
| Comparative | 6.6 | 9.0 | 13.0 | 5.3 | 1.7 | 1.7 | 0.9 | 1.8 | 4.4 | 60.0 |
| Example 4 | | | | | | | | | | |
| Comparative | 6.7 | 9.0 | 13.0 | 5.7 | 1.7 | 1.7 | 0.7 | 1.4 | 3.8 | 59.9 |
| Example 5 | | | | | | | | | | |
| Comparative | 7.7 | 10.3 | 12.6 | 2.9 | 1.8 | 0.9 | 1.0 | 2.0 | 3.9 | 60.7 |
| Example 6 | | | | | | | | | | |
| Comparative | 5.6 | 7.4 | 10.9 | 0.7 | 3.0 | 7.6 | 1.5 | 3.0 | 12.1 | 60.2 |
| Example 7 | | | | | | | | | | |

By using the obtained glass frit, the composition (or the paste) for forming a black enamel coating configured with 76% of the glass frit, 8.4% of 2-(2-butoxyethoxy)ethyl acetate, 12.5% of terpineol, and 3.1% of ethyl cellulose, and it is then printed on a Planitherm Dura Plus (a brand name, a glass substrate to which a single Low-E coating is applied) that is a Low-E glass manufactured by Glass Industry Co., Ltd. Korea according to a screen printing method. After this, it is dried for more than twenty minutes at a temperature of 100° C., and it is heat-treated for 230 seconds at 700° C. thereby obtaining a coated article to which the black enamel coating is formed.

Each the coated article is evaluated as follows.

Evaluation of Black Color Quality

The color coordinates is measured by reflecting the color on the opposite side on which no black enamel coating is formed. When the absolute values of a* and b* of the color coordinates are less than 1, they may be seen to express an excellent black color.

Measurement of Surface Roughness

The roughness is measured on the side on which the black enamel coating is formed.

When the surface roughness is less than 1, it may be seen to have a commercially excellent surface.

Evaluation of Acid Resistance

The state of the black enamel coating is evaluated as follows after being exposed to a 3% HCl aqueous solution at room temperature for five minutes.

1: No changes

2: Slight deterioration of gloss is generated.

3: Change of color on the surface is imperceptible and the gloss is somewhat deteriorated.

4: Substantial changes of color on the surface are observed, and the coating is easily peeled off by physical scratches.

5: Enamel coating is peeled from the substrate.

The cases of 1 to 3 may have commercially usable acid resistance.

The results are expressed in Table 3.

TABLE 3

| | Evaluation of black color | | | |
|---|---|---|---|---|
| | (Reflection color on non-coated | | Surface | |
| | side) | | roughness | Acid |
| | a* | B* | (μm) | resistance |
| Exemplary | −0.35 | −0.62 | 0.69 | 3 |
| Embodiment 1 | | | | |
| Exemplary | −0.39 | 0.15 | 0.83 | 3 |
| Embodiment 2 | | | | |
| Exemplary | −0.28 | 0.32 | 0.86 | 3 |
| Embodiment 3 | | | | |
| Exemplary | 0.43 | −0.77 | 0.69 | 2 |
| Embodiment 4 | | | | |
| Comparative | 0.82 | −5.09 | 0.13 | 3 |
| Example 1 | | | | |
| Comparative | 5.43 | 4.79 | 0.33 | 3 |
| Example 2 | | | | |
| Comparative | 0.48 | 9.87 | 0.71 | 3 |
| Example 3 | | | | |
| Comparative | 1.52 | −0.69 | 7.48 | 3 |
| Example 4 | | | | |
| Comparative | 1.12 | −0.18 | 3.67 | 3 |
| Example 5 | | | | |
| Comparative | −0.03 | −2.46 | 4.54 | 3 |
| Example 6 | | | | |
| Comparative | 0.2 | −1.47 | 11.89 | 4 |
| Example 7 | | | | |

As expressed in Table 3, according to exemplary embodiments of the present invention, the absolute values of a* and b* values of the color coordinates are less than 1, so it is found that the excellent black color is realized without including a black pigment. Further, when applied to the glass substrate on which a multilayer thin film coating including a metallic functional layer with an infrared ray reflection function is formed, the surface roughness is less than 1 μm, showing an excellent surface characteristic. In addition, it is found that, regarding the evaluation of acid resistance, the gloss deteriorated degree indicates acid resistance of equal to or greater than grade 3.0n the contrary, compared with the glass frit in the comparative examples, when only one of elements of Co, Ni, and Fe is included as shown in Comparative Examples 1-3, it is found that, even when the content of the above included element is in a range of their sum in the present invention, quality of the black color is deteriorated. Further, when Co, Ni, and Fe are all included but their sum or a content of one element is not included in the range of the present invention as shown in Comparative Examples 4-7, it is found that it is bad at the surface roughness or the acid resistance, or it fails to express the excellent black color.

The present invention is not limited to the exemplary embodiments and may be produced in various forms, and it will be understood by those skilled in the art to which the present invention pertains that exemplary embodiments of the present invention may be implemented in other specific forms without modifying the technical spirit or essential features of the present invention. Therefore, it should be understood that the aforementioned exemplary embodiments are illustrative in terms of all aspects and are not limited.

1. A glass frit for forming a black enamel coating comprising
Si at 6.5 mol % to 6.9 mol %, B at 9.0 mol % to 9.3 mol %, Bi at 13.0 mol % to 13.4 mol %, Zn at 6.0 mol % to 6.3 mol %, and Al at 1.5 mol % to 2.0 mol %, and
Co, Ni, and Fe, wherein a total amount of Co, Ni, and Fe is 2.9 mol % to 3.5 mol % of the glass frit in a molar ratio.

2. The glass frit of claim 1, wherein
a content of Co is 1 to 2 mol %, a content of Ni is 0.5 to 1.1 mol %, and a content of Fe is 0.5 to 1.5 mol % of the glass frit in a molar ratio.

3. The glass frit of claim 2, comprising
Si at 6.6 mol % to 6.8 mol %, B at 9.0 mol % to 9.2 mol %, Bi at 13.1 mol % to 13.3 mol %, Zn at 6.1 mol % to 6.3 mol %, Al at 1.7 mol % to 1.8 mol %, Co at 1.0 mol % to 2.0 mol %, Ni at 0.5 mol % to 1.1 mol %, and Fe at 0.5 mol % to 1.5 mol % in a molar ratio.

4. The glass frit of claim 1, further comprising
at least one selected from Na and Li at more than 0 and less than 1 mol %.

5. A composition for forming a black enamel coating, comprising:
the glass frit of claim 1; and
an organic vehicle.

6. The composition of claim 5, wherein
the composition does not include a pigment for developing a black color.

7. A coated article comprising:
a transparent substrate, a multilayer thin film coating disposed on the transparent substrate, and a patterned portion having a black enamel coating formed on at least part of the transparent substrate as a predetermined pattern,
wherein the multilayer thin film coating includes a first dielectric layer, a metallic functional layer having an infrared reflection function, and a second dielectric layer, which are sequentially disposed in a direction away from the transparent substrate, and
the black enamel coating is formed from a glass frit comprising Si at 6.5 mol % to 6.9 mol %, B at 9.0 mol % to 9.3 mol %, Bi at 13.0 mol % to 13.4 mol %, Zn at 6.0 mol % to 6.3 mol %, Al at 1.5 mol % to 2.0 mol %, and Co, Ni, and Fe, wherein a total amount of Co, Ni, and Fe is 2.9 mol % to 3.5 mol % of the glass frit in a molar ratio.

8. The coated article of claim 7, wherein
a surface roughness (Ra) of the black enamel coating is less than 1 μm.

9. The coated article of claim 7, wherein
CIELAB color coordinates (a* and b*) of a reflection color of a surface, on which side the black enamel coating is not formed in a patterned portion, are −1.0 to 1.0.

10. The coated article of claim 7, wherein
a thickness of the black enamel coating is from 5 μm to 30 μm.

11. A method for manufacturing a coated article, comprising:
printing a composition for forming a black enamel coating so as to have a predetermined pattern on at least part of a transparent substrate having a multilayer thin film coating thereon; and
forming a patterned portion including the black enamel coating by carrying out a heat treatment of the transparent substrate on which the multilayer thin film coating and the composition for forming the black enamel coating are formed,
wherein the composition for forming the black enamel coating comprises a glass frit comprising Si at 6.5 mol % to 6.9 mol %, B at 9.0 mol % to 9.3 mol %, Bi at 13.0 mol % to 13.4 mol %, Zn at 6.0 mol % to 6.3 mol %, Al at 1.5 mol % to 2.0 mol %, and Co, Ni, and Fe, wherein a total amount of Co, Ni, and Fe is 2.9 mol % to 3.5 mol % of the glass frit in a molar ratio, and an organic vehicle, and
the multilayer thin film coating comprises a first dielectric layer, a metallic functional layer having an infrared reflection function, and a second dielectric layer, which are sequentially disposed in a direction away from the transparent substrate.

12. The manufacturing method as claimed in claim 11, wherein
the heat treatment is carried out at a temperature of 630° C. to 730° C. for 150 seconds to 300 seconds.

13. The manufacturing method as claimed in claim 11, wherein
components in the glass frit are entirely melted by the heat treatment so as to exist as one phase.

14. The manufacturing method as claimed in claim 11, further comprising
drying and preheating the composition for forming the black enamel coating before the heat treatment.

15. The manufacturing method as claimed in claim 11, wherein
the heat treatment is a tempering process of the transparent substrate.
